(19) United States
(12) Patent Application Publication
(10) Pub. No.: US 2013/0209906 A1
(43) Pub. Date: Aug. 15, 2013

(54) REACTANT CONTROL METHOD FOR A FUEL CELL SYSTEM IN IDLE-STOP MODE

(71) Applicants: Daniel I. Harris, Honeoye Falls, NY (US); John P. Salvador, Penfield, NY (US)

(72) Inventors: Daniel I. Harris, Honeoye Falls, NY (US); John P. Salvador, Penfield, NY (US)

(73) Assignee: GM GLOBAL TECHNOLOGY OPERATIONS LLC, Detroit, MI (US)

(21) Appl. No.: 13/372,129

(22) Filed: Feb. 13, 2012

(51) Int. Cl. H01M 8/04

(52) U.S. Cl. 429/429

(57) ABSTRACT

A system and method for controlling the reactants in anode and cathode compartments of a fuel cell stack while the fuel cell stack is in a stand-by or idle-stop mode. The method includes identifying a voltage set-point for an average voltage of the fuel cells in the fuel cell stack or an overall stack voltage that is a minimum voltage acceptable for the idle-stop mode. The actual cell voltage average or stack voltage is compared to the voltage set-point to generate a voltage error. The voltage error is provided to a controller that does one or both of providing hydrogen gas to the anode compartment of the stack to increase the anode compartment pressure, which decreases the voltage error if the voltage is above the voltage set-point, or providing more cathode air to the cathode compartment of the fuel cell stack if the voltage error is below the voltage set-point.

### BACKGROUND OF THE INVENTION

1. Field of the Invention

This invention relates generally to a system and method for controlling the reactants within a fuel cell stack while the stack is in a stand-by or idle-stop mode and, more particularly, to a system and method for controlling the reactants within a fuel cell stack while the stack is in a stand-by or idle-stop mode, where the method does one or both of controlling the anode compartment pressure by providing hydrogen to the anode compartment of the stack or controlling the cathode air flow to the cathode compartment of the stack.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode compartment of the stack. The stack also includes flow channels through which a cooling fluid flows.

The fuel cell stack includes a series of bipolar plates positioned between the several MEAs in the stack, where the bipolar plates and the MEAs are positioned between the two end plates. The bipolar plates include an anode compartment and a cathode compartment for adjacent fuel cells in the stack. Anode gas flow channels are provided on the anode compartment of the bipolar plates that allow the anode reactant gas to flow to the respective MEA. Cathode gas flow channels are provided on the cathode compartment of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

During the normal operation of a fuel cell system (FCS), some parasitic losses occur that reduce system efficiency. These losses include diffusion of hydrogen from the anode compartment of the stack to the cathode compartment of the stack, electrical short-circuiting and ancillary power consumption from, for example, pumps, compressor, etc. When electrical power is not desired from the fuel cell stack, the parasitic losses can be reduced by reducing the flow of reactants to the fuel cell system.

There are occasions when the fuel cell vehicle requires very little power, such as when the fuel cell vehicle is stopped at a stop light. Providing normal reactant flows to the fuel cell stack is generally wasteful in these situations, since reactant permeation and electric loads of balance of plant components can be very significant. It is generally desirable to reduce stack output power and current draw during these idle conditions to improve system fuel efficiency.

For these and possibly other fuel cell system operating conditions, it may be desirable to put the system in a stand-by or idle-stop mode where the system is consuming little or no power, the quantity of fuel being used is minimal and the system can quickly recover from the stand-by mode so as to increase system efficiency and reduce system degradation. U.S. patent application Ser. No. 12/723,261, titled Standby Mode for Optiminazation of Efficiency in Durability of a Fuel Cell Vehicle Application, filed Mar. 12, 2010, assigned to the assignee of this application and herein incorporated by reference, discloses one known process for putting a fuel cell system on a vehicle in a stand-by mode to conserve fuel.

As reactant flows during a stand-by or idle-stop mode are reduced and the concentration of reactants in the anode and cathode compartments decrease, undesirable conditions in the fuel cell stack can develop. For example, without the flow of air to the cathode compartment of the stack, hydrogen permeates through the membranes and accumulates in the cathode compartment, where it forms a hydrogen/nitrogen/water mixture. Subsequently, when power is demanded from the fuel cell system, the hydrogen rich gas in the cathode compartment may need to be mixed with diluents to prevent excessive hydrogen in the vehicle exhaust. This dilution process slows the restart of the fuel cell system and can cause undesirable performance lags.

Moreover, maintaining a hydrogen-rich concentration in the anode compartment throughout the stand-by mode is also important. Without sufficient hydrogen supplied to the anode compartment, oxygen that is present in the cathode compartment can permeate to the anode compartment. Significant local concentrations of both oxygen and hydrogen in different areas of the anode compartment can cause a hydrogen-air front, which can cause significant carbon corrosion of the cathode electrode, as is well understood by those skilled in the art.

To control oxygen accumulation in the anode compartment or hydrogen accumulation in the cathode compartment, precise control of the air and hydrogen reactants to the fuel cell stack is critical.

### SUMMARY OF THE INVENTION

In accordance with the teachings of the present invention, a system and method are disclosed for controlling the reactants in anode and cathode compartments of a fuel cell stack while the fuel cell stack is in a stand-by or idle-stop mode. The method includes identifying a voltage set-point for an average voltage of the fuel cells in the fuel cell stack or an overall stack voltage that is a minimum voltage acceptable for the idle-stop mode. The actual cell voltage average or stack voltage is compared to the voltage set-point to generate a voltage error. The voltage error is provided to a controller that does one or both of providing hydrogen gas to the anode compartment of the stack to increase the anode compartment pressure, which decreases the voltage error if the voltage is above the voltage set-point, or providing more cathode air to the cathode compartment of the fuel cell stack if the voltage error is below the voltage set-point.

Additional features of the present invention will become apparent from the following description and appended claims, taken in conjunction with the accompanying drawings.

### BRIEF DESCRIPTION OF THE DRAWINGS

FIG. 1 is a simple schematic block diagram of a fuel cell system;

FIG. 2 is a graph with time on the horizontal axis and voltage error and anode pressure at different locations on the vertical axis showing a relationship between anode pressure and the voltage error;

FIG. 3 is a closed-loop control system that controls the anode compartment pressure or cathode compartment air flow when a fuel cell stack is in an idle-stop mode; and

FIG. 4 is a graph with time on the horizontal axis and voltage error and cathode flow at different locations on the vertical axis showing a relationship between the voltage error and the cathode flow.

### DETAILED DESCRIPTION OF THE EMBODIMENTS

The following discussion of the embodiments of the invention directed to a system and method for controlling the reactants within a fuel cell stack when the stack is in a stand-by or idle-stop mode is merely exemplary in nature, and is in no way intended to limit the invention or its applications or uses. For example, the present invention has particular application for a fuel cell system on a vehicle. However, as will be appreciated by those skilled in the art, the system and method of the invention may have other applications.

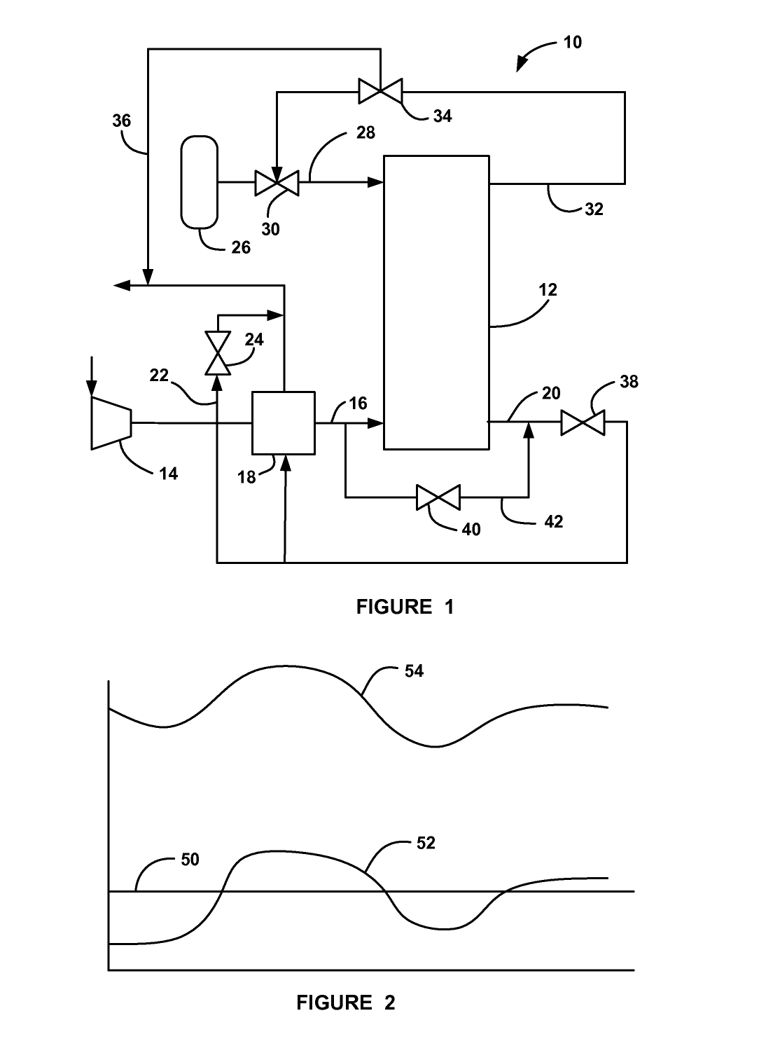

FIG. 1 is a schematic block diagram of a fuel cell system 10 including a fuel cell stack 12. A compressor 14 provides airflow to the cathode compartment of the fuel cell stack 12 on a cathode input line 16 through, for example, a water vapor transfer (WVT) unit 18 that humidifies the cathode input air. A cathode exhaust gas is output from the stack 12 on a cathode exhaust gas line 20, which directs the cathode exhaust to the WVT unit 18 to provide the humidity to humidify the cathode input air. A back pressure valve 38 is provided in the exhaust gas line 20, which is controlled to control the pressure within the cathode compartment of the fuel cell stack 12. A by-pass line 22 is provided around the WVT unit 18 to direct some or all of the cathode exhaust gas around the WVT unit 18. In an alternate embodiment, the by-pass line 22 can be an inlet by-pass. A by-pass valve 24 is provided in the by-pass line 22 and is controlled to selectively direct the cathode exhaust gas through or around the WVT unit 18 to provide the desired amount of humidity to the cathode input air. A by-pass line 42 is provided around the fuel cell stack 12 and a proportional valve 40 is provided in the by-pass line 42 to control how much of the airflow from the compressor 14 is directed through the stack 12 and how much is directed around the stack 12.

The fuel cell stack 12 receives hydrogen from a hydrogen source 26 that injects hydrogen gas into the anode compartment of the fuel cell stack 12 on an anode input line 28 by an injector 30. An anode exhaust gas is output from the fuel cell stack 12 on a recirculation line 32 that recirculates the anode exhaust back to the anode input by providing it to the injector 30 that may operate as an injector/ejector, well known to those skilled in the art. One suitable example of an injector/ejector is described in U.S. Pat. No. 7,320,840, entitled “Combination of Injector-Ejector for Fuel Cell Systems,” assigned to the assignee of this application and herein incorporated by reference. As is well understood in the art, nitrogen accumulates in the anode compartment of the stack 12 that reduces the concentration of hydrogen therein, and affects the performance of the system 10. A bleed valve 34 is provided in the recirculation line 32 to periodically bleed the exhaust gas to remove nitrogen from the anode sub-system. The bled anode exhaust gas is provided on a bleed line 36 to the cathode exhaust line 20.

When the stack 12 goes into a stand-by or idle-stop mode, reactants are present in the anode and cathode compartments of the stack 12. Typically most of the oxygen in the cathode is slowly consumed, either by a small stack load or membrane permeation, in combination with limited or no cathode air delivery. However, as discussed above, hydrogen and oxygen continue to diffuse through the MEA and plumbing as soon as the stand-by or idle-stop mode is initiated. A voltage produced by the fuel cells in the stack 12 suggests the presence of oxygen in the cathode compartment of the stack 12 and hydrogen in the anode compartment of the stack 12, where the presence of oxygen in the cathode compartment limits the accumulation of hydrogen in the cathode compartment. Too high of a voltage may indicate that enough oxygen is present in the cathode compartment to diffuse to the anode compartment and pose a durability concern. A desired voltage can thus be determined that indicates optimal reactant concentration in the anode compartment and the cathode compartment of the stack 12 during the stand-by or idle-stop mode. Increasing the anode compartment pressure by adding hydrogen to the anode compartment will increase the permeation rate of hydrogen to the cathode compartment. Hydrogen that has permeated to the cathode compartment will react with oxygen in the cathode compartment and reduce the voltage.

One embodiment of the present invention proposes defining a voltage set-point (VSP) that identifies a desirable stack or fuel cell voltage that addresses the concerns discussed above when the stack 12 is in a stand-by or idle-stop mode. The voltage set-point can be any low voltage level, such as 100 mV, suitable for a stand-by mode voltage for the cells. In one embodiment, it is an average voltage of the cells that is used as the VSP. In another embodiment, the overall stack voltage is used as the VSP.

FIG. 2 is a graph with time on the horizontal axis, voltage error at the bottom of the vertical axis and anode pressure at the top of the vertical axis. Graph line 50 represents the voltage set-point and graph line 52 represents the calculated or measured voltage, such as the average cell voltage. Graph line 54 shows an anode pressure change within the anode compartment of the stack 12 that is used to control the voltage error by injecting hydrogen into the anode compartment of the stack 12, discussed in more detail below. Hydrogen that permeates to the cathode compartment of the stack 12 will react with oxygen and reduce the cell voltage, which causes the anode compartment pressure to decrease, and increases the voltage error. Adding hydrogen to the anode compartment of the stack 12 causes the anode compartment pressure to increase, which causes hydrogen to cross over to the cathode compartment, which reduces the voltage error. Thus, it can be shown that by controlling the anode compartment pressure by, for example, injecting hydrogen into the anode compartment, corrections to the voltage error can be obtained.

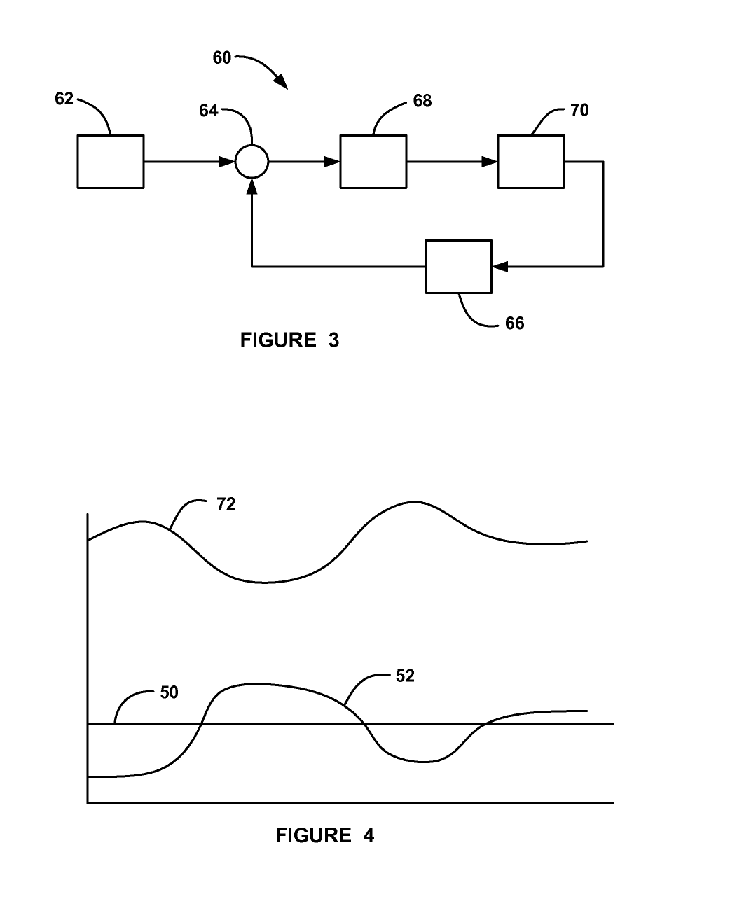

FIG. 3 is a block diagram of a control system 60 that can be used to control the stack voltage or average cell voltage during the idle-stop mode. The voltage set-point is provided from box 62 to a comparator 64 and the average cell voltage or stack voltage is provided by a voltage measurement device 66, or other suitable circuit, to the comparator 64. A typical fuel cell system will monitor both stack voltage and average cell voltage for various purposes and many circuits and algorithms are know in the art for this purpose. The difference between the voltage set-point and the actual voltage is the voltage error, represented by the graph line 52, which is provided to a controller 68. Depending on whether the voltage error is above or below the set-point, represented by the line 50, determines whether the controller 68 will cause the injector 30 to inject hydrogen into the fuel cell stack 12, represented by box 70. As mentioned above, if the voltage error is increasing and going above the set-point line 50, then the controller 68 will cause hydrogen to be injected into the stack 12, which causes the voltage error to decrease with a lag. The controller 68 will stop the injection of hydrogen at some point, which may cause the voltage error to overshoot the set-point line 50. Consumption of hydrogen within the stack 12 will again cause the voltage error to move back towards the set-point line 50, where the controller 68 will again cause the injector 30 to inject hydrogen into the stack 12.

In an alternate embodiment, the control system 60 can be used to control the flow of air to the cathode compartment of the stack 12 to control and reduce the voltage error. Adding air to the cathode compartment of the stack 12 will displace and/or consume hydrogen in the cathode compartment. As oxygen is absorbed on the cathode electrode surfaces, the cell voltage will increase. In other words, when the voltage below set point, not enough oxygen is present in the cathode compartment of the stack 12, where hydrogen from the anode compartment diffuses to the cathode compartment faster than the rate that oxygen is coming into the cathode compartment.

The above described condition can be shown in FIG. 4 which is a graph with time on the horizontal axis and voltage error on the vertical axis showing the same voltage error and set-point lines 50 and 52, respectively, as in FIG. 2. The vertical axis also includes a cathode flow graph line 72 that represents adjustments in cathode air in the cathode compartment of the stack 12 in response to the voltage error.

As is apparent from the comparison of the graph lines 52 and 72, if the voltage error is below, or moving towards, the set-point line 50, then the controller 68 increases the air in the cathode compartment of the stack 12, and when the voltage error is above the set-point line 50, the controller 68 reduces, or allows the reduction of cathode air in the cathode compartment of the stack 12. In this embodiment, the controller 68 would do one or more of increase the speed of the compressor 14 to provide more air, adjust the position of the by-pass valve 40 to reduce the air by-pass and adjust the position of the back-pressure valve 38 to reduce the flow of air out of the stack 12.

Alternately, the control system 60 can control both the amount of hydrogen in the anode and the flow of air to the cathode simultaneously or part of the same control.

In alternate embodiments, other parameters other than voltage can be used to generate the error signal. For example, concentration sensors can be employed to generate a concentration error where the control system 60 would provide more gas to the anode compartment and/or more cathode air to the cathode compartment to cause the concentration to go to a desired concentration set-point.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for controlling one or more reactants in a fuel cell stack when the fuel cell stack is in a stand-by or idle-stop mode, said method comprising:
identifying a stack parameter that changes during operation of the fuel cell stack;
identifying a desired set-point of the parameter for the stand-by or idle-stop mode;
monitoring the parameter when the stack is in the stand-by or idle-stop mode;
comparing the set-point to the parameter during the stack stand-by or idle mode to generate an error therebetween; and
reducing the error by providing one or both of hydrogen to an anode compartment of the fuel cell stack or air to a cathode compartment of the fuel cell stack.

2. The method according to claim 1 wherein identifying a stack parameter and identifying a desired set-point include identifying a stack voltage and stack voltage set-point.

3. The method according to claim 1 wherein identifying a stack parameter and identifying a desired set-point include identifying an average cell voltage of fuel cells in the stack and an average cell voltage set-point.

4. The method according to claim 1 wherein reducing the error by providing one or both of hydrogen to an anode compartment of the fuel cell stack or air to a cathode compartment of the fuel cell stack includes providing hydrogen to the anode compartment of the fuel cell stack.

5. The method according to claim 4 wherein providing hydrogen to the anode compartment of the fuel cell stack includes injecting hydrogen into the anode compartment of the fuel cell stack using an injector.

6. The method according to claim 1 wherein reducing the error by providing one or both of hydrogen to an anode compartment of the fuel cell stack or air to a cathode compartment of the fuel cell stack includes controlling a speed of a compressor that provides air to the cathode compartment of the fuel cell stack.

7. The method according to claim 1 wherein reducing the error by providing one or both of hydrogen to an anode compartment of the fuel cell stack or air to a cathode compartment of the fuel cell stack includes controlling a position of a by-pass valve in a by-pass line that directs air around the fuel cell stack.

8. The method according to claim 1 wherein reducing the error by providing one or both of hydrogen to an anode compartment of the fuel cell stack or air to a cathode compartment of the fuel cell stack includes controlling a position of a back-pressure valve in a cathode compartment exhaust line from the fuel cell stack.

9. The method according to claim 1 wherein the fuel cell stack is on a vehicle and the stand-by or idle-stop mode is initiated when the vehicle is stopped.

10. A method for controlling one or more reactants in a fuel cell stack when the fuel cell stack is in a stand-by or idle-stop mode, said method comprising:
identifying a desired set-point for an average cell voltage of fuel cells in the fuel cell stack or a stack voltage for the stand-by or idle-stop mode;
monitoring the average cell voltage of fuel cells in the fuel cell stack or the stack voltage when the stack is in the stand-by or idle-stop mode;
comparing the set-point to the average cell voltage of fuel cells in the fuel cell stack or the stack voltage during the stack stand-by or idle-stop mode to generate an error therebetween; and
reducing the error by providing hydrogen to an anode compartment of the fuel cell stack.

11. The method according to claim 10 wherein reducing the error by providing hydrogen to an anode compartment of the fuel cell stack includes injecting hydrogen into the anode compartment of the fuel cell stack using an injector.

12. The method according to claim 10 wherein the fuel cell stack is on a vehicle and the stand-by or idle-stop mode is initiated when the vehicle is stopped.

13. A method for controlling one or more reactants in a fuel cell stack when the fuel cell stack is in a stand-by or idle-stop mode, said method comprising:
identifying a desired set-point for an average cell voltage of fuel cells in the fuel cell stack or a stack voltage for the stand-by or idle-stop mode;
monitoring the average cell voltage of fuel cells in the fuel cell stack or the stack voltage when the stack is in the stand-by or idle-stop mode;
comparing the set-point to the average cell voltage of fuel cells in the fuel cell stack or the stack voltage during the stack stand-by or idle-stop mode to generate an error therebetween; and
reducing the error by providing additional air to a cathode compartment of the fuel cell stack.

14. The method according to claim 13 wherein reducing the error by providing additional air to a cathode compartment of the fuel cell stack includes controlling a speed of a compressor that provides air to the cathode compartment of the fuel cell stack.

15. The method according to claim 13 wherein reducing the error by providing additional air to a cathode compartment of the fuel cell stack includes controlling a position of a by-pass valve in a by-pass line that directs the air around the fuel cell stack.

16. The method according to claim 13 wherein reducing the error by providing additional air to a cathode compartment of the fuel cell stack includes controlling a position of a back-pressure valve in a cathode compartment exhaust line from the fuel cell stack.

17. The method according to claim 13 wherein the fuel cell stack is on a vehicle and the stand-by or idle-stop mode is initiated when the vehicle is stopped.
